(19) United States
(12) Patent Application Publication
(10) Pub. No.: US 2013/0212462 A1
(43) Pub. Date: Aug. 15, 2013

(54) METHOD AND APPARATUS FOR DISTRIBUTED SCRIPT PROCESSING

(71) Applicant: Nokia Corporation, (US)

(72) Inventors: Gregory Joseph Athas, Lisle, IL (US); Derek Tyner, Raleigh, NC (US); James W. Lent, Durham, NC (US); Yevgeniy Rabinovich, Northbrook, IL (US); Mark Debiase, Apex, NC (US); Olga Gerchikov, Buffalo Grove, IL (US); Piotr Buczak, Des Plaines, IL (US)

(73) Assignee: Nokia Corporation, Espoo (FI)

(21) Appl. No.: 13/612,298

(22) Filed: Sep. 12, 2012

Related U.S. Application Data
(60) Provisional application No. 61/534,564, filed on Sep. 14, 2011.

(51) Int. Cl. G06F 17/22

(52) U.S. Cl. CPC G06F 17/2247
USPC 715/234

(57) ABSTRACT

An approach is provided for providing a low-power browsing experience on a mobile device. A proxy platform receives a request for a webpage. The proxy platform also receives information about the mobile device. The proxy platform processes and/or facilitates a processing of the information about the mobile device and sends the webpage to the mobile device in a format that is based on the information about the mobile device. The mobile device may then operate in a low-power mode when browsing the requested website.

### RELATED APPLICATIONS

This application claims benefit of the earlier filing date under 35 U.S.C. §119(e) of U.S. Provisional Application Ser. No. 61/534,564 filed Sep. 14, 2011, entitled “Method and Apparatus for Distributed Script Processing,” the entirety of which is incorporated herein by reference.

### BACKGROUND

Wireless (e.g., cellular) service providers and device manufacturers are continually challenged to deliver value and convenience to consumers by, for example, providing compelling network services, applications, and content. In light of an increasingly web-centric culture, one emerging service is the use of wireless devices to access web services. However, limited resources within the wireless environment (e.g., bandwidth, processing power) and/or battery power can limit access to such web services on mobile devices, particularly when accessing web content with complex and potentially resource-intensive scripts (e.g., JavaScript) provide advance web applications and/or functionality. Accordingly, service providers and device manufacturers face significant technical challenges to overcome such limitations by enabling efficient and secure access to web services via, for example, a proxy server.

### SOME EXEMPLARY EMBODIMENTS

Therefore, there is a need for an approach for providing a browsing experience to enable access to advanced functions that rely on script-based interactions and related web technologies.

According to one embodiment, a method comprises receiving a request, from a device to a proxy server, for rendering web content including one or more scripts. The method further comprises processing and/or facilitating a processing of the web content, the one or more scripts, or a combination thereof to cause, at least in part, a determination of (a) whether to reuse media previously stored at the device for rendering the web content; (b) whether to generate a partial update of the web content; (c) whether to cause, at least in part, a processing of at least a portion of the web content, the one or more scripts, or a combination thereof using one or more local resources of the device; or (d) a combination thereof. The method also comprises causing, at least in part, the rendering of the web content based, at least in part, on the determination for transmission to the device.

According to another embodiment, an apparatus comprises at least one processor, and at least one memory including computer program code for one or more programs, the at least one memory and the computer program code configured to, with the at least one processor, cause, at least in part, the apparatus to receive a request, from a device to a proxy server, for rendering web content including one or more scripts. The apparatus is further caused to process and/or facilitate a processing of the web content, the one or more scripts, or a combination thereof to cause, at least in part, a determination of (a) whether to reuse media previously stored at the device for rendering the web content; (b) whether to generate a partial update of the web content; (c) whether to cause, at least in part, a processing of at least a portion of the web content, the one or more scripts, or a combination thereof using one or more local resources of the device; or (d) a combination thereof. The apparatus also causes, at least in part, the rendering of the web content based, at least in part, on the determination for transmission to the device.

According to another embodiment, a computer-readable storage medium carries one or more sequences of one or more instructions which, when executed by one or more processors, cause, at least in part, an apparatus to receive a request, from a device to a proxy server, for rendering web content including one or more scripts. The apparatus is further caused to process and/or facilitate a processing of the web content, the one or more scripts, or a combination thereof to cause, at least in part, a determination of (a) whether to reuse media previously stored at the device for rendering the web content; (b) whether to generate a partial update of the web content; (c) whether to cause, at least in part, a processing of at least a portion of the web content, the one or more scripts, or a combination thereof using one or more local resources of the device; or (d) a combination thereof. The apparatus also causes, at least in part, the rendering of the web content based, at least in part, on the determination for transmission to the device.

According to another embodiment, an apparatus comprises means for receiving a request, from a device to a proxy server, for rendering web content including one or more scripts. The apparatus further comprises means for processing and/or facilitating a processing of the web content, the one or more scripts, or a combination thereof to cause, at least in part, a determination of (a) whether to reuse media previously stored at the device for rendering the web content; (b) whether to generate a partial update of the web content; (c) whether to cause, at least in part, a processing of at least a portion of the web content, the one or more scripts, or a combination thereof using one or more local resources of the device; or (d) a combination thereof. The apparatus also comprises means for causing, at least in part, the rendering of the web content based, at least in part, on the determination for transmission to the device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing distributed script processing, according to one embodiment;

FIG. 2 is a diagram of components of a proxy server for providing distributed script processing for media reuse, according to one embodiment;

FIG. 3A is a diagram of components of a proxy server for providing distributed script processing for performing partial updates, according to one embodiment;

FIG. 3B is a diagram depicting a document object model (DOM) comparison for performing partial updates, according to one embodiment;

FIG. 4A is a diagram of components of a proxy server for providing distributed script processing for using local device resources, according to one embodiment;

FIG. 4B is a time-sequence diagram depicting a process for providing distributed script processing for using local device resources, according to one embodiment;

FIG. 5 is a flowchart of a process for providing distributed script processing, according to one embodiment;

FIG. 6 is a flowchart of a process for providing distributed script processing for media reuse, according to one embodiment;

FIG. 7 is a flowchart of a process for providing distributed script processing for performing partial updates, according to one embodiment;

FIG. 8 is flowchart of a process for providing distributed script processing for using local device resources, according to one embodiment;

FIGS. 9A-9D are diagrams of user interfaces used in the processes of FIGS. 1-8, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile station (e.g., handset) that can be used to implement an embodiment of the invention.

### DESCRIPTION OF PREFERRED EMBODIMENT

A method and apparatus for providing a distributed script processing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to providing a distributed script processing browsing experience within a wireless network environment, it is contemplated that the various embodiments of the approach described herein may be used within any type of communication system or network and with any mode of communication available of the network (e.g., data communications, Internet communication, voice communication, text communication, etc). In addition, although the various embodiments are further described with respect to mobile devices, it is contemplated that the various embodiments are applicable to any type of device with network access (e.g., stationary terminals, personal computers, etc.).

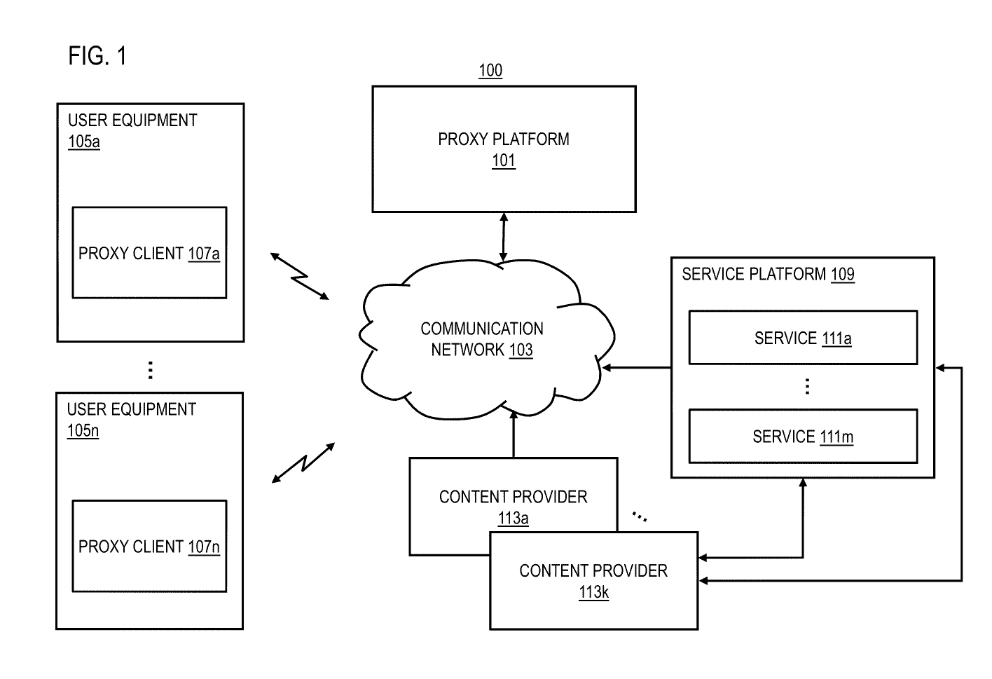

FIG. 1 is a diagram of a communication system capable of providing distributed script processing, according to one embodiment. As discussed previously, implementing mobile web services within a wireless environment can potentially tax the relatively limited resources (e.g., bandwidth, processing power, memory, battery power, etc.) that are available within the environment (e.g., within a mobile device). Moreover, as web-based applications become more sophisticated by employing the latest web technologies (e.g., scripting via languages such as JavaScript), the problem of having sufficient resources at mobile devices to support new applications also increases.

On traditional way to address this problem is use a proxy web browser. By way of example, a proxy web browser is one where the rendering of a web page (e.g., HTML, CSS, JavaScript) is performed on a remote server on behalf of a requesting client application. Typically, the client application is a simplified version of a full web browser. However, these proxy browsers can also suffer some inefficiencies. For example, in commonly deployed proxy web browsing solutions, script-driven (e.g., JavaScript-driven) user interaction with web content (e.g., a web page or a web application) generally requires that a request is made back to the proxy server and that an entirely new representation of the client web page is returned back to the client. This can, for instance, require the delivery of large amounts of redundant and unnecessary data to the client as well as potentially long loading times waiting for the web content to reloaded and rendered.

To address this problem, a system 100 of FIG. 1 introduces the capability to provide for distributed script processing. The various embodiments of distributed script processing described herein enhances the proxy web browsing experience by reducing, or in some cases, eliminating the need to transmit an entire fresh copy of the web page each time a scripting event occurs during display of web content. In one embodiment, the system 100 can employ at least three approaches to distributed script processing to reducing network traffic, resource usage, etc. associated with proxy web browsing of script-based web content. By way of example, the three approaches include, but are not limited to:
(1) Session Media Caching: When a script event (e.g., a JavaScript event) is initiated from the client and sent to the server, the subsequent response of the modified full page document of the requested web content can be delivered to the client with only newly referenced media items (e.g., images, sounds, videos, etc.). The client will retain and reuse media used by the document for the duration of the active session unless otherwise indicated by the proxy server.
(2) Partial Page Updates: After a scripting event is initiated by the client, the server can execute the one or more scripts in the request and modify the target document or web content. Before sending the document back to the client, the proxy server can compare the newly created document to the original document. In this way, the proxy server can deliver only the differences between that the documents. Through a set of predefined commands, the client can then rendered the new document based only on the changes or differences from the original document.
(3) Pass-through Scripts: In one embodiment, the client can support use of local resources to execute certain scripts (e.g., using a scripting library such as a Mobile Web Library (MWL) to enable local execution of certain JavaScript functions). This library, for instance, enables the client to perform actions like switching tabs, sliding between images, hiding/showing content, etc. In this case, any web content that uses MWL or functions available in the MWL can pass the MWL methods to the client without execution by the proxy server. In some embodiments, the MWL may provide for access to native functions on the device such as geolocation, touch-based controls, initiation of communication sessions, etc. Under this scenario, the proxy server can also pass MWL methods for accessing these native functions to the client.

As shown in FIG. 1, the system 100 comprises a proxy platform 101 (e.g., a proxy server) that provides for proxy web browsing over the communication network 103. In one embodiment, the system 100 enables users (e.g., via user equipment (UEs) 105a-105n—also collectively referred to as UEs 105) to be able to receive web content by way of the proxy platform 101. As previously discussed, proxy browsing is a technology that reduces the amount of data that needs to be transferred between a web server and a web browser. An intermediate proxy server located between a mobile device and the Internet may, for example, be used to reduce image sizes, simplify the HTML markup of a webpage, and compress transmitted data. Proxy browsing also allows for a reduction in hardware requirements for internet enabled mobile devices, faster rendering of webpages, and reduced bandwidth usage.

The system 100 further includes a proxy browsing architecture which consists of one or more proxy clients 107a-107n (also collectively referred to as proxy clients 107) operating within respective client devices (e.g., UEs 105a-105n). In one embodiment, the proxy clients 107 route at least a portion of the communication traffic from the UEs 105 through the proxy platform 101. In some embodiments, the proxy clients 107 may be a browser application. In addition or alternatively, the proxy clients 107 can be independent processes executing in the UEs 105, or can be incorporated in other applications executing in the UEs 105.

In one embodiment, the proxy platform 101 receives requests from the proxy clients 107 to route communication traffic to the intended communication endpoints. In addition, the proxy platform 101 can route return communication traffic from the communication endpoints to the any of the proxy clients 107 and/or UEs 105. By way of example, the communication endpoints can include a service platform 109, the services 111a-111m (also collectively referred to as services 111), the content providers 113a-113k (also collectively referred to as content providers 113), or any other component with connectivity to the communication network 103 (e.g., another UE 105). For example, the service platform 109, the service 111, and/or the content providers 113 may provide any number of services (e.g., mapping services, social networking services, media services, content services, etc.) via a web server or other means of communications (e.g., text messaging, voice, instant messaging, chat, etc.). In other words, the communication endpoints represent a terminating point of communications from the proxy clients 107, and an originating point of communications to the proxy clients 107.

In some embodiments, the proxy platform 101 receives requests from the proxy clients 107 to view a service content, such as a webpage, web application, or other web content, and the proxy platform 101 can perform any number of communications related functions for routing and/or processing the resulting communication traffic. For example, as noted above, the proxy platform 101 can provide an optimized distributed script processing experience by delivering only new images of the web content, providing partial updates based on document mutations or differences, enabling pass-through or scripts for on-device changes (e.g., changes to CSS properties, CSS3 transitions, etc.). In other embodiments, the proxy platform 101 may compress or otherwise modify content that is to be delivered to the proxy clients 107 based, at least in part, on one or more capabilities or characteristics of the receiving UE 105. For example, in wireless environments, the proxy platform 101 can compress data for more efficient transmission, transform content to reduce the amount of data for transfer, reformat content for display in smaller screens, change the content to an image file, etc. The proxy platform 101 may divide the service content into a series of subparts that may be equally or unequally parsed and sent to the UE 105 like a deck of cards based on any of the display capabilities or resolution of a display, available memory, a battery condition, and/or available power mode settings of the UE 105.

By way of example, the UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 105 can support any type of interface to the user (such as “wearable” circuitry, etc.).

Additionally, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

Communication is facilitated between the UE 105 and the proxy platform 101 via the communication network 103 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the proxy clients 107 and the proxy platform 101 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

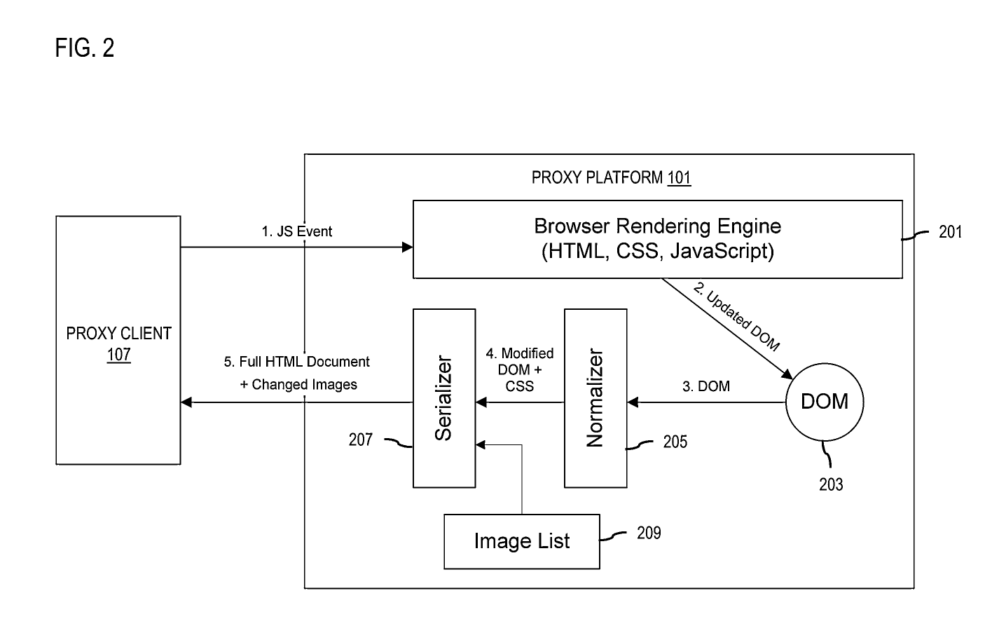

FIG. 2 is a diagram of components of a proxy server for providing distributed script processing for media reuse, according to one embodiment. By way of example, the proxy platform 101 includes one or more components for providing distributed script processing. It is contemplated that the functions of these components may be combined in one or more components or performed by other components of equivalent functionality. In one embodiment, the proxy platform 101 includes a browser rendering engine 201 for rendering web content based one or more scripting events. More specifically, the browser rendering engine 201 interprets web code and scripts (e.g., HTML, CSS, JavaScript) to generate or otherwise update a document object model (DOM) 203 to represent the rendering of the web content. The proxy platform 101 then uses a normalizer module 205 to process or modify the DOM 203 based, at least in part, on the capabilities and or requirements of the proxy client 107. The normalizer module 205 then interacts with the serializer module 207 to generate or render the web document that is to be sent to the proxy client 107 for display. In one embodiment, the serializer module 207 has connectivity to an image list module 209 to provide script processing functions related, at least in part, to media reuse or smart image update. By way of example, smart image update is a mechanism for the proxy client 107 to reuse images on a single web page when using distributed scripts.

Traditionally, the proxy client 107 would not store images in memory across requests to the proxy platform 101. Consequently, the proxy platform 101 would have to send down the entire set of images contained in requested web content. This would be true for requests for new pages as well as same-page requests. In one embodiment, same-page requests are web content requests that go back to the proxy platform 101, but do not change the full path of the address or Universal Resource Location (URL) being requested. Most of the same-page requests are script events (e.g., JavaScript events) such as callbacks. In one embodiment, with smart image update, the proxy client 107 keeps images in memory across same-page requests.

To perform smart image update or media reuse on the server side, the proxy platform 101 maintains at least two image lists 209. One image list 209 is the current request list which maintains a list of media items in the DOM 203 of the current request. Another image list 209 is the current page list which maintains a list of images that were already sent down to the proxy client for the address or URL currently being handled. In one embodiment, the current page list is reset (cleared or emptied) every time the URL or address of the request changes. For every each request, the proxy platform 101 checks the media items (e.g., images) in the current request list against the current page list. If an image or media item in the current request list exists in the current page list, the image or media item is not sent down to the proxy client 107, thereby reducing network traffic and bandwidth usage. If the image or media item does not exist, the image or media item is sent to the proxy client 107 and added to the current page image list.

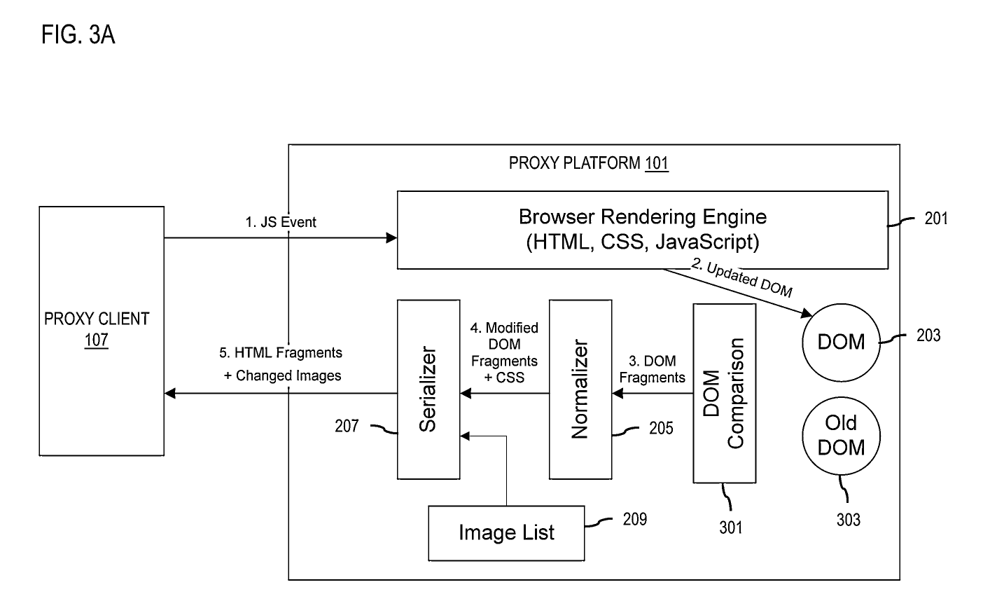

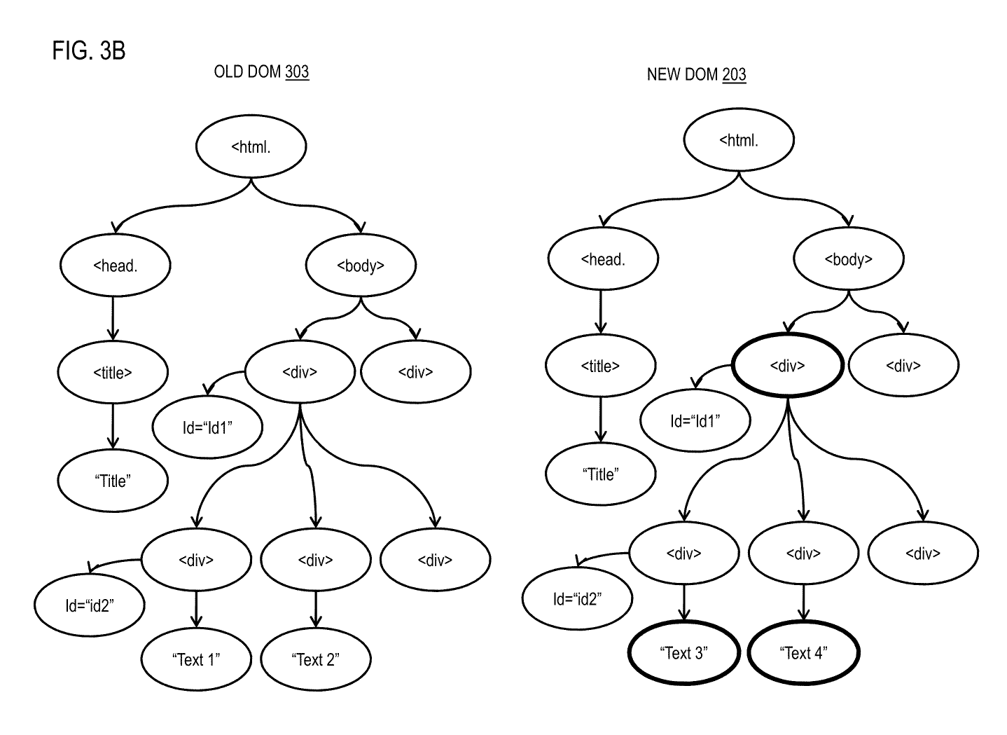

FIG. 3A is a diagram of components of a proxy server for providing distributed script processing for performing partial updates, according to one embodiment. As shown in FIG. 3A the proxy platform 101 includes the same components as described with respect to FIG. 2 with the additional of a DOM comparison module 301 and an old DOM 303 for performing partial updates. As previously described, the proxy platform 101 can perform partial page updates in response to script events to, for instance, reduce the amount of data that is transmitted to the proxy client 107 if a callback changes only a portion of the DOM or the request web content.

In one embodiment, building a partial page response is based, at least in part, on determining how the web content request (e.g., a script callback request) has changed the web content or the old DOM 303. By way of example, this is accomplished by saving a copy of the DOM before the callback request is executed (henceforth referred to as the old DOM 303). The DOM comparison module 301 can then compare the old DOM 303 to the DOM 203 after the callback request is processed (henceforth referred to as the new DOM 203). In one embodiment, the DOM comparison module 301 uses an algorithm to recursively walk through the two DOMs 203 and 303 (e.g., depth first) in parallel looking for differences. Although, the description below is with respect to a particular algorithm, it is contemplated that the DOM comparison module 301 can use any process to determine differences between the DOMs 203 and 303. When a node of the two DOMs 203 and 303 is identified as different, the DOM comparison module 301 can search for an ancestor node in the new DOM 203 with an ID attribute (by returning from the recursion). If an ancestor node is found, then that node is added to a list of modified nodes. If no ancestor node with an ID attribute is found, then the DOM comparison module 301 stops and a partial page update is not sent.

In one embodiment, before a node is added to the modified node list, the DOM comparison module 301 can prune from the list any subtending nodes already in the list. By way of example, the DOM comparison module 301 does this by storing the size of the list when it starts recursively walking each node's children. The walk then continues with the parent node just added to the modified node list. It is noted that there is no reason to check any more children of the node added to the list because the child nodes would already be impacted.

In another embodiment, as the DOM comparison module 301 compares the two DOMs 203 and 303, the module 301 keeps track of the number nodes in the new DOM 203 that have not changed and the number of nodes that subtend the list of modified nodes. The DOM comparison module 301 can then use this information as one of the factors for determining whether a partial page update is recommended. In some embodiments, the DOM comparison module 301 can ignore a subset of attributes and tags that are designated as not significant. In addition, the DOM comparison module 301 can be configured to ignore nodes associated with insignificant whitespaces.

FIG. 3B is a diagram depicting a document object model (DOM) comparison for performing partial updates, according to one embodiment. More specifically, FIG. 3B shows the structure of an old DOM 303 before a callback request and a new DOM 203 after the callback request is processed by the proxy platform 101. To perform a partial update, the proxy platform 101 identifies what has changed in the new DOM 203 and communicate this information to the proxy client 107.

A summary of how the DOM comparison module 301 would identify the differences between the two DOMs 203 and 303 is summarized as follows:
Node (1) matches, continue with first (and only) child (2)
Node (2) matches, continue with first (and only) child (3)
Node (3) matches, continue with first (and only) child (4)
Node (4) matches, since no children return to the first ancestor node with another child (1) and proceed to its next child (5)
Node (5) matches, continue with first child (6)
Node (6) matches including its attribute node (7), continue with first child (8)
Node (8) matches including its attribute node (9), continue with first (and only) child (10)
Node (10) does not match:
   return to the first node with an id attribute (8)
   add (8) to the list
   return to that node's parent node (6)
   proceed with that nodes next child (11)
Node (11) matches, continue with first (only) child (12)
Node (12) does not match:
   return to the first node with an id attribute (6),
   remove the subtending node (8) from the list
   add (6) to the list
   return to that node's parent node (5)
   proceed with its next child (13)
   note that we did not visit the third child of node (6)
Node (13) matches, since no children return the first ancestor node with another child (there are not any)
Done.

In one embodiment, once the DOM comparison module 301 has identified the nodes that have subtending changes, these changes are communication to the proxy client by sending the changes in, for instance, a set of MWL script commands (e.g., JavaScript commands). By of example, each node with a subtending change adds an MWL “insertHTML” method call to the response. This method allows the proxy platform 101 to replace the existing HTML for a specified node with new HTML expressed as a string. The node to update is identified by its ID attribute. If the call back processing creates any new styles, then this is communicated to the proxy client 107 by adding an MWL “addNewStyle” method call to the response for each new style. The “addNewStyle” method calls are added to the response before the “insertHTML” method calls.

In one embodiment, if no changes are detected, then a response (e.g., a 204 HTTP NO CONTENT response) is sent to the proxy client 107. If the DOM comparison module 301 determines that the changes so large (e.g., above a threshold value of modified nodes) that a partial page update is not desirable, then the proxy platform 101 can sent a response that includes the HTML for the entire new page.

By way of example, when the proxy client 107 receives a callback response, the proxy client 107 will process it as appropriate. For example, if a 204 (HTTP NO CONTENT) response is received from the proxy platform 101, no additional changes will be done to the DOM on the proxy client 107. If the proxy platform 101 sent a partial page update to the proxy client 107, then the client 107 will execute the MEL methods (e.g., “insertHTML” and “addNewStyle”) in the partial page update to the current DOM. If the proxy platform 101 response was the HTML for the entire new page, the client will replace the current DOM with the DOM corresponding to the new HTML. However, in some embodiments, the proxy client will keep using all of the media (e.g., images) from the old page, and all the MWL timers for the page will continue running

In some embodiments, MWL statements executed at the proxy client 107 can change the state of the DOM, for example, when displaying a hidden block of content. In this case, the DOM on the proxy platform 101 will not be aware of the changes made on the proxy client 107. Accordingly, without DOM synchronization, when a callback request is made to the proxy platform 101, the resulting response may undo changes that were made on the proxy client 107.

To avoid this situation, the proxy platform 101 and the proxy client 107 may use DOM synchronization. With DOM synchronization, every event handler that is executed at the proxy client 107 is tracked and sent to the proxy platform 101 as part of the callback request. The proxy client 107 will track all event handlers that were executed on the client, and the order they were executed in. When the client executes a MWL.callback( ) statement, the proxy client 107 can send a HTTP POST request to the server. The POST request will include DOM synchronization data as well as the current value of all input fields on the page, and all other data that the proxy platform 101 uses to distinguish the current webpage and browser session from others. Once the proxy client 107 sends a MWL.callback( ) request to the proxy platform 101, the proxy client 107 can discard the information about previously executed event handlers. Next time the proxy client 107 executes the MWL.callback( ) the proxy client 107 can send to the proxy platform 101 just the DOM synchronization data for event handlers that were executed since the previous MWL.callback( ).

In one embodiment, while processing the callback, the proxy platform 101 will process DOM synchronization data in the callback request. For each DOM synchronization event, the proxy platform 101 will get the contest of the event handler from the original DOM, extract any MWL statements and execute them against the original DOM. After all the DOM synchronization events have been processed, the original DOM on the proxy platform 101 will have the same state as the DOM on the proxy client 107. In some embodiments, the proxy platform 101 will then normalize the original DOM; this is done so that any changes made by the synchronization process will not be resent back to the proxy client by the DOM comparison process.

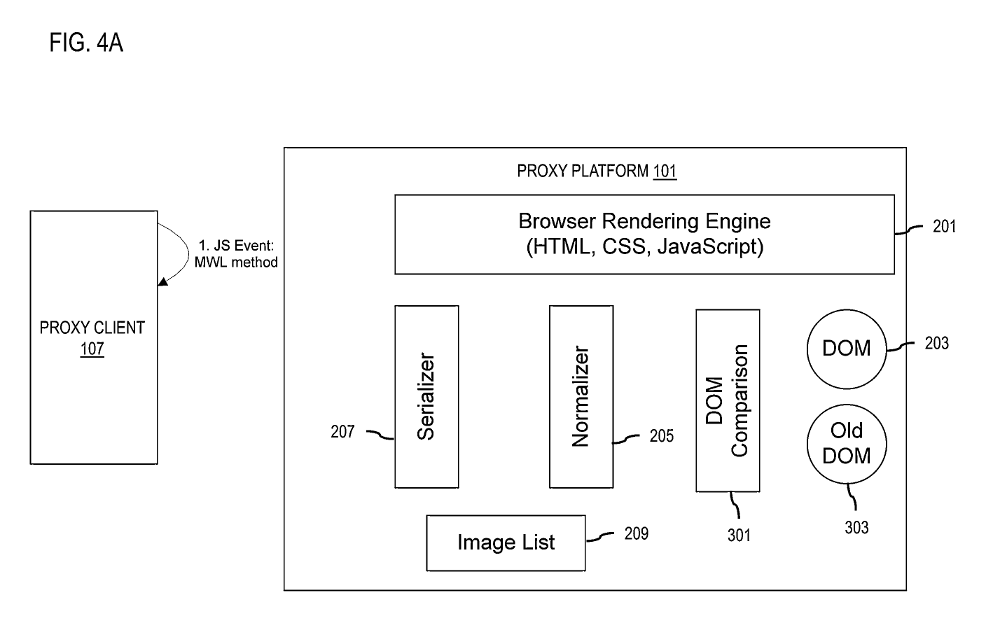

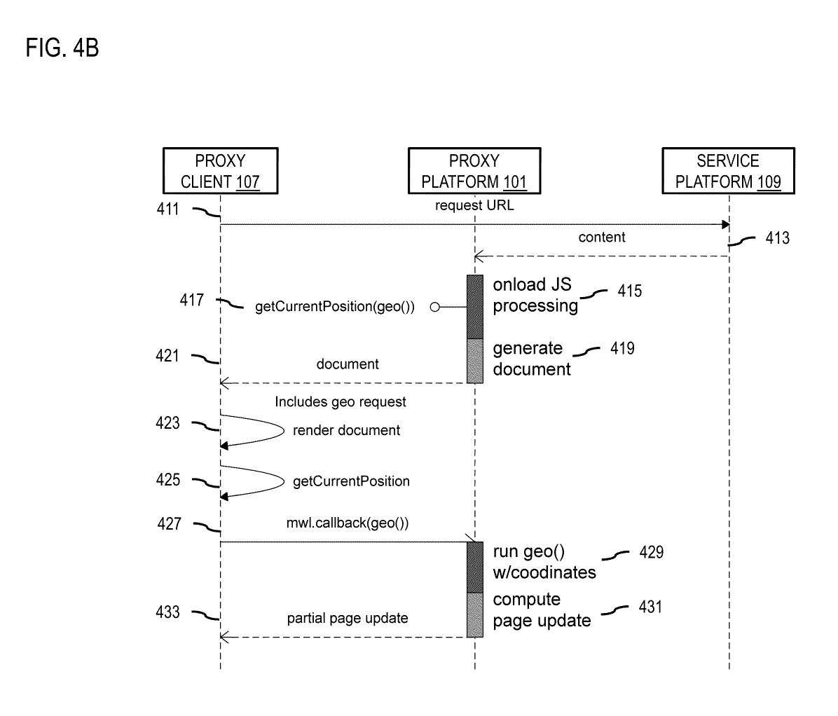

FIG. 4A is a diagram of components of a proxy server for providing distributed script processing for using local device resources, according to one embodiment. In one embodiment, access to the local device resources is by way of the MWL. As previously noted, MWL is a script (e.g., JavaScript) library to handle basic on device operations. In one embodiment, the MWL can be implemented natively in the proxy client 107. MWL methods are invoked inline to execute on the proxy client 107. Examples of MWL methods include “addClass”, “removeClass”, “toggleClass”, “switchClass”, “setGroupTarget”, “setGroupNext”, “iterateClass”, “show”, “hide”, “toggle”, “setInputValue”, “insertHTML”, “replaceChild”, “scrollTo”, and the like. As shown in FIG. 4A, the components of the proxy platform 101 for using local device resources (e.g., MWL), are the same as described with respect to FIG. 3A.

In this case, the proxy platform 101 and the proxy client 107 support MWL. By way of example, support for MWL and non-MWL scripts is enabled on events such as onload, onunload, onclick, onchange, and the like. The proxy platform 101 will strip non-MWL scripts before sending to the proxy client 107. In one embodiment, MWL statements are left alone and remain in the order specified on the event. Non-MWL statements are aggregated and converted to a single MWL.callback( ) statement that will be sent by the proxy clients 107 to the proxy platform 101 for server-side script processing when the applicable event occurs.

In another embodiment, the proxy platform 101 can run all non-MWL scripts specified in the onload event before sending the DOM to the proxy client 107. Any remaining statements in the event will be MWL statements that the proxy client should run when the document is loaded.

In certain embodiments, some event handlers support both MWL which is executed on the proxy client 107 and scripts (e.g., JavaScript) which is executed on the proxy platform 101. During the translation, the proxy platform 101 can examine the statements in each event handler. The MWL statements will be left as-is while any script (e.g., JavaScript) statements will be replaced by a MWL.callback( ) statement which will make a request to the proxy platform 101 to execute the script statements and return any updates made to the DOM. By way of example, similar translation is performed for MWL statements which add synthetic event listeners and MWL statements that support scripts in their arguments.

In one embodiment, when the proxy client 107 detects an event with a MWL handler, the proxy client will execute all the methods in the MWL serially, in the order specified by the handler. Most MWL methods make changes to the DOM, and the proxy client 107 will display the updated DOM once the changes are made. Some MWL methods (MWL.callback( )) require sending a request to the proxy platform 101 and waiting for a reply before executing other methods and updating the DOM.

In yet another embodiment, distributed script processing includes support for starting, running, and stopping timers. The proxy platform 101 can include methods for starting and stopping timers along with other methods in an event. Each timer method call specifies how many times the timer should run, the duration, and the MWL methods to be executed when the timer runs. When the MWL start timer method is executed on the proxy client 107, the proxy client 107 will determine when the methods specified by the timer is to be run the next time. The proxy client 107 can run methods specified by the timer at the appropriate time, and if there are any runs left, determine when the timer needs to run again. MWL stop timer method can stop execution of a specific timer (or all timers) that has been scheduled to be run at a future time.

FIG. 4B is a time-sequence diagram depicting a process for providing distributed script processing for using local device resources, according to one embodiment. FIG. 4B is an example use case of accessing a local device resource that is a native function of the device (e.g., geolocation). A network process is represented by a vertical line. A step or message passed from one process to another is represented by horizontal arrows. The processes represented in the FIG. 4B are the proxy client 107, the proxy platform 101, and the service platform 109.

At 411, the proxy client 107 sends a request for a URL via the proxy platform 101 to the service platform 109. In response, the service platform 109 returns content to the proxy platform 101 (at 413). The proxy platform 101 processes the content via, for instance, a JavaScript (JS) engine (at 415) and encounters a getCurrentPosition(geo( )) request (at 417). The proxy platform 101 saves the request for the next response and converts the location request (e.g., geo( )) into a callback format and generates a corresponding document (at 419) for transmission to the proxy client 107 (at 421). By way of example, the geo( ) request is sent in the document as a MWL command (in callback) and is embedded into the document as, for instance, onload( ) content.

At 425, the proxy client 107 renders the document (at 423) and executes the native function to getCurrentPosition (at 425). In one embodiment, the geolocation is accessed through the W3C HTML4 Geolocation API, which can determine the client 107's location through GPS, cell tower triangulation, etc. When geolocation is found, the proxy client 107 sends a callback (MWL.callback(geo( )) to the proxy platform 101 (at 427). The proxy platform 101 executes the script requesting the geolocation with the provided coordinates (at 429) and computes the resulting page update (at 431). The proxy platform 101 can then send a partial page update with the DOM modified based on execution of the script with the geolocation to the proxy client 107 for rendering (at 433).

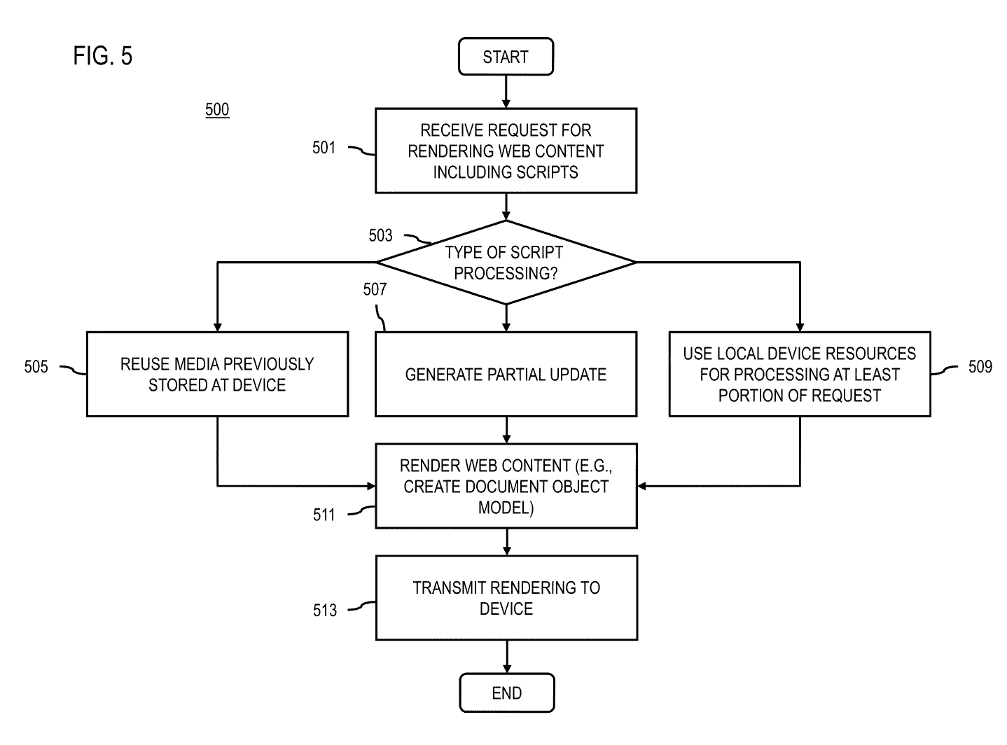

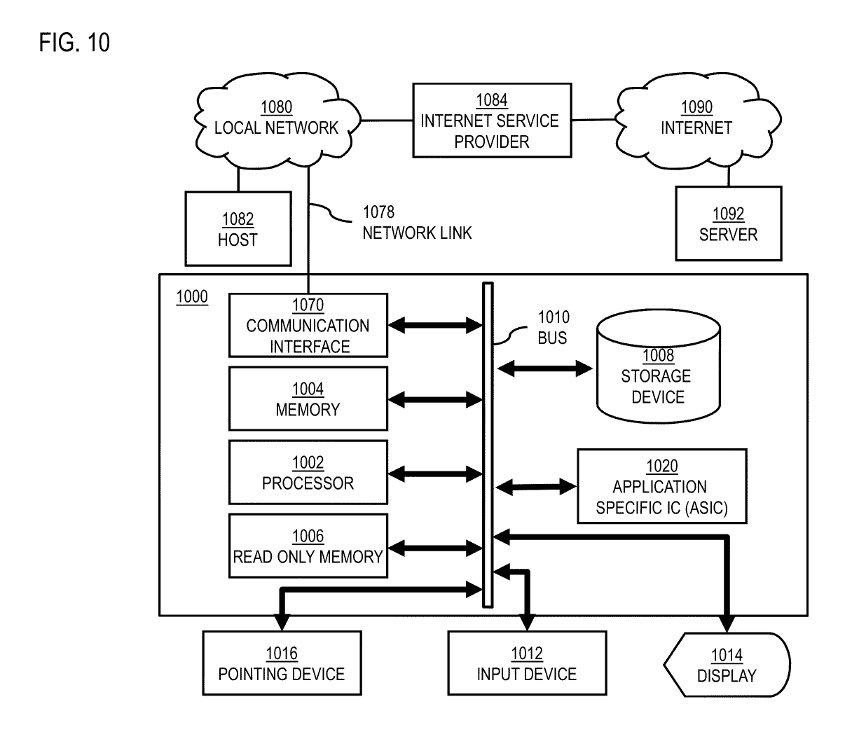

FIG. 5 is a flowchart of a process for providing distributed script processing, according to one embodiment. In one embodiment, the proxy platform 101 performs the process 500 and is implemented in, for instance, a chip set including a processor and a memory as shown FIG. 10. At step 501, the proxy platform 101 receives a request, from a device to a proxy server, for rendering web content including one or more scripts. The platform then determines the type of script processing to perform (at step 503).

In other words, the proxy platform 101 processes and/or facilitates a processing of the web content, the one or more scripts, or a combination thereof to cause, at least in part, a determination of (a) whether to reuse media previously stored at the device for rendering the web content (step 505); (b) whether to generate a partial update of the web content (step 507); (c) whether to cause, at least in part, a processing of at least a portion of the web content, the one or more scripts, or a combination thereof using one or more local resources of the device (step 509); or (d) a combination thereof.

The proxy platform 101 then causes, at least in part, the rendering of the web content based, at least in part, on the determination (step 511) for transmission to the device (step 513). As described above, the rendering can be based on generating and/or modifying a document object model incorporating HTML code, CSS, scripts, etc. for rendering the requested web content at the device.

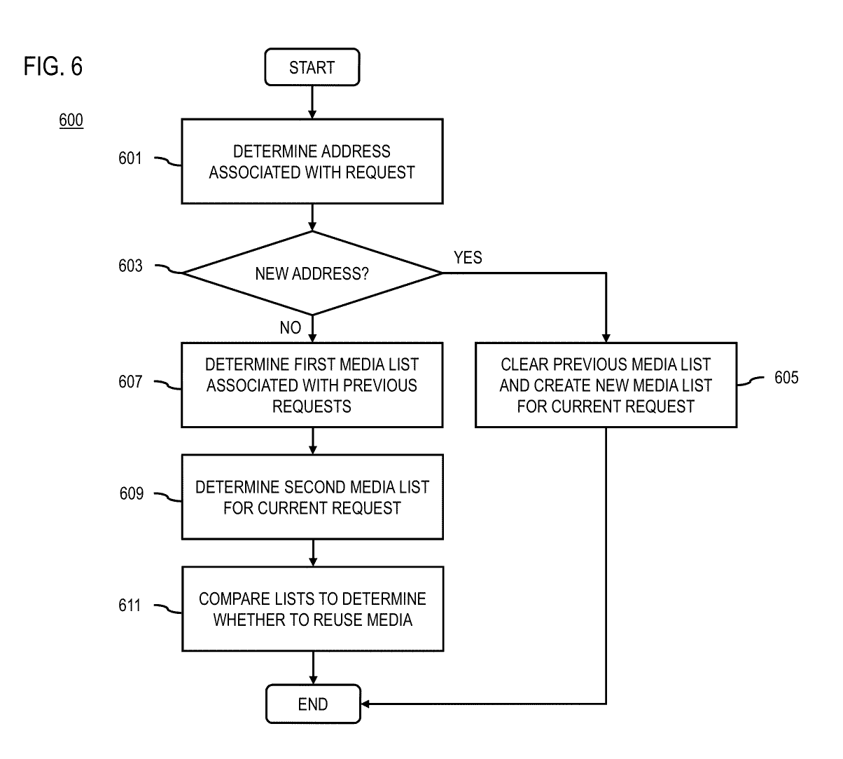

FIG. 6 is a flowchart of a process for providing distributed script processing for media reuse, according to one embodiment. In one embodiment, the proxy platform 101 performs the process 600 and is implemented in, for instance, a chip set including a processor and a memory as shown FIG. 10. The process 600 is based on a determination via the process 500 to perform a smart image update or other media reuse.

Accordingly, at step 601, the proxy platform 101 processes and/or facilitates a processing of the request to determine an address (e.g., a URL) associated with the requested web content. The proxy platform 101 also determines whether the request specifies, at least in part, a new address associated with the web content (step 603). If the address is a new address, the proxy platform 101 causes, at least in part, a clearing or resetting of the current page media list (e.g., a first media list), the current request media list (e.g., a second media list), or a combination thereof (step 605). Any media items used for responding to the web content request can then be added to the current page media list.

If the address is not new (e.g., indicating the web content request is associated with a previous session), the proxy platform 101 determines a first media list associated with one or more previous requests related to the address associated with the web content (step 607). The proxy platform 101 also causes, at least in part, a generation of a second media list associated with the request (step 609). Next, the proxy platform 101 determine whether to reuse the media previously stored at the device based, at least in part, on a comparison of the first media list and the second media list (step 611). In one embodiment, the media previously stored at the device is cached or otherwise maintained across a plurality of web content requests.

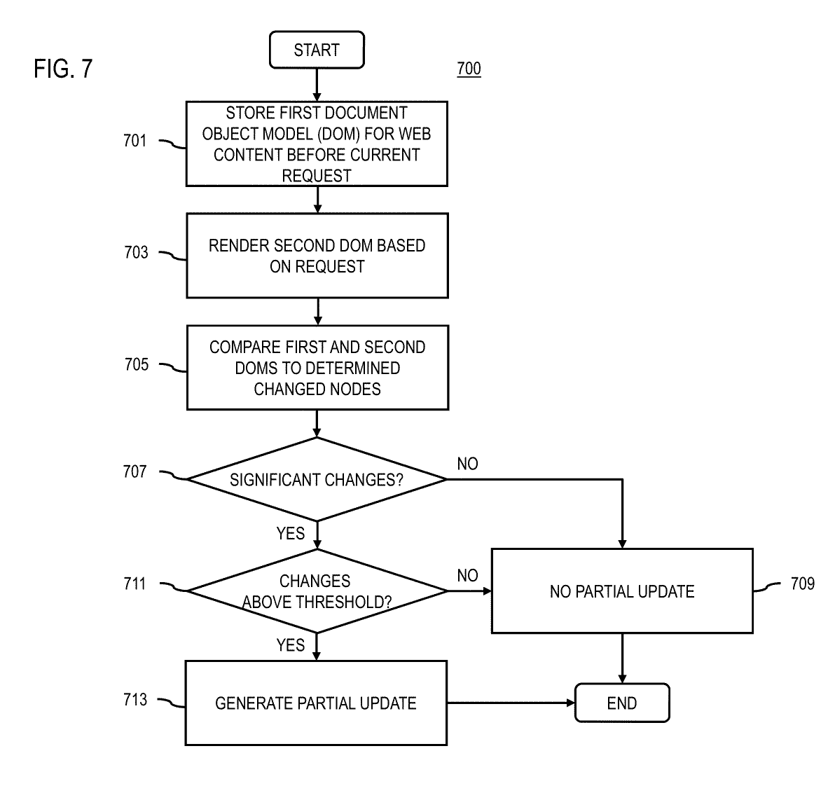

FIG. 7 is a flowchart of a process for providing distributed script processing for performing partial updates, according to one embodiment. In one embodiment, the proxy platform 101 performs the process 700 and is implemented in, for instance, a chip set including a processor and a memory as shown FIG. 10. The process 700 is based on a determination via the process 500 to perform a partial page update.

At step 701, the proxy platform 101 causes, at least in part, a storage of a first document object model associated with the web content rendered prior to receiving the request. The proxy platform 101 then processes and/or facilitates a processing of the request to render a second document object model associated with the web content (step 703). At step 705, the proxy platform 101 determines one or more nodes of the first document object model, the second document object model, or a combination thereof that have changed based, at least in part, on a comparison of the first document object model and the second document object model.

In one embodiment, the proxy platform 101 can determine whether the one or more nodes that have changed are associated with a subset of one or more attributes, one or more tags, one or more whitespaces, or a combination (step 707). The subset may, for instance, be associated with tags or attributes that do not significantly affect the DOMs. In other words, the changes in these nodes are not significant to the overall document. If the changes are not significant, the proxy platform 101 does not perform a partial update (step 709). If the changes are significant, the proxy platform 101 can then determine a ratio of the one or more nodes that have changed to the one or more nodes that have not changed. The proxy platform 101 then determines whether the ratio indicates that the number of changes is above predetermined threshold values (step 711). If the changes are so large or numerous, the proxy platform 101 may perform a full update of the entire document or web page instead of a partial update. If the ratio indicates the changes are below the threshold values, the proxy platform 101 may perform a partial update based, at least in part, on the one or more nodes that have changed (step 713).

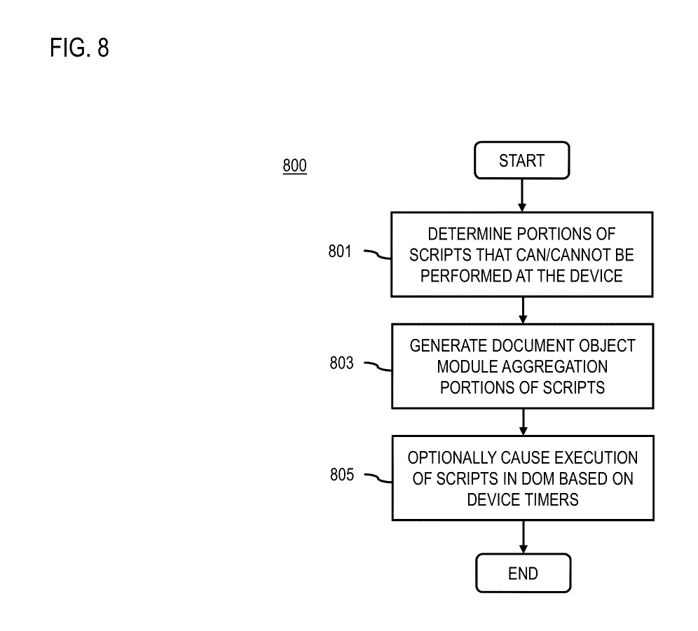

FIG. 8 is flowchart of a process for providing distributed script processing for using local device resources, according to one embodiment. In one embodiment, the proxy platform 101 performs the process 800 and is implemented in, for instance, a chip set including a processor and a memory as shown FIG. 10. The process 800 is based on a determination via the process 500 to use local device resources for script processing.

In addition, the process 800 assumes that one or more local resources of the device include, at least in part, one or more local scripting functions (e.g., the MWL). Accordingly, at step 801, the proxy platform 101 determines a first portion of the one or more scripts associated with the request that can be performed by the one or more scripting functions, a second portion of the one or more scripts that cannot be performed by the one or more scripting functions, or a combination thereof. The proxy platform 101 then causes, at least in part, a generation of a document object model for the rendering of the requested web content that includes the first portion for local execution, the second portion for execution at the proxy server, or a combination thereof (step 803).

In some embodiments, the one or more local resources of the device also include one or more native device functions (e.g., geolocation). Under this scenario, the proxy platform 101 can determine that the one or more scripts are for access to the one or more native device functions, and then determine to cause, at least in part, the device to provide the one or more native device functions for execution of the one or more scripts.

At step 805, the proxy platform 101 can optionally determine one or more timers associated with executing the first portion of the one or more scripts, the second portion of the one or more scripts, or a combination thereof. In one embodiment, the one or more timers are managed at the device for coordinating the timing and/or order of the execution of the one or more scripts.

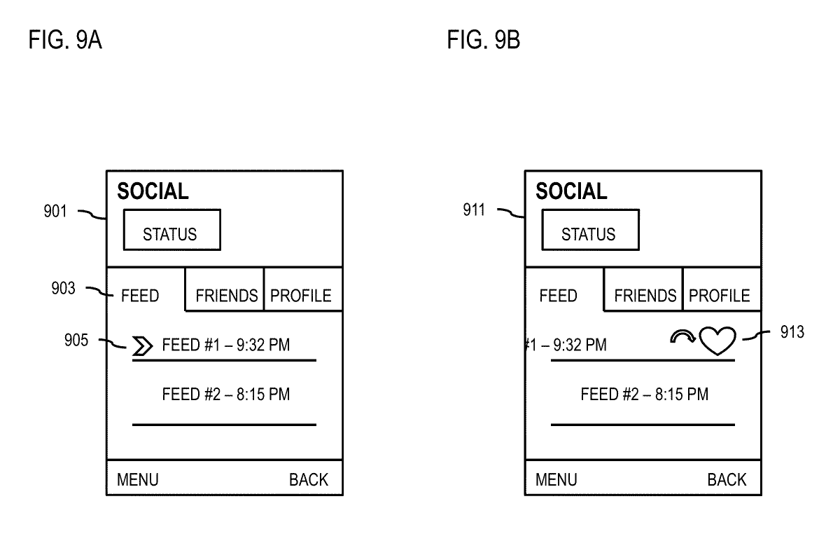

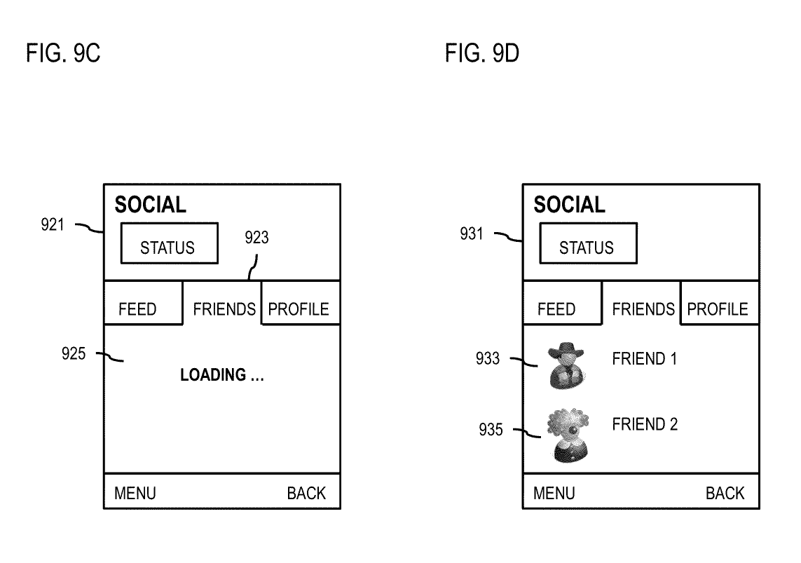

FIGS. 9A-9D are diagrams of user interfaces used in the processes of FIGS. 1-8, according to various embodiments. FIG. 9A depicts a user interface 901 of after an initial loading of a social web application. For example, a user selects the web application from the proxy client 107 for processing via the proxy platform 101. The proxy platform 101 requests the web application from, for instance, the service platform 109 which returns content (e.g., metadata, HTML, CSS, JavaScript, images, etc.) associated with the web application. The proxy platform 101 processes the content to create a DOM and associated with JavaScript context for the web application. The proxy platform 101 creates a client-optimized HTML/CSS document from the DOM and includes JavaScript event handlers wrapped as MWL callbacks. In this case, MWL event handlers are passed through to the proxy client 107.

As shown in user interface 901, the Feed Tab 903 of the web application is selected, and the feed information 905 is presented along with a control button to show more information. In this example, the user clicks on the control button of the feed information 905 which invokes the corresponding MWL event handler. As shown in user interface 911 of FIG. 9B, the local DOM is updated to slide the feed information 905 to the left to reveal additional controls 913 for manipulating the feed 905. Because the MWL event is handled exclusively using local resources, no interaction with the proxy platform 101 is needed to create the transition from user interface 901 to user interface 911. In one embodiment, the proxy client 107 MWL local actions are logged for later synchronization with the DOM of the proxy platform 101.

FIGS. 9C and 9D depict an example that combines local MWL processing and a partial page update by the proxy platform 101. In the user interface 921 of FIG. 9C, a user has selected to switch tabs to the Friends Tab 923. On clicking the tab 923, the MWL switches tabs and shows the loading message 925. At the same time, a callback is invoked, and the logged MWL events are also sent with the callback. At the proxy platform 101, the script engine runs the logged MWL events to synchronize the DOM at the proxy platform 101 with the DOM at the proxy client 107. The callback also invokes the script event handler to change the display from the Feed Tab 903 to the Friends Tab 923. Accordingly, the proxy platform 101 access the friends information (e.g., via AJAX requests for data). The invoked script is then used to modify the DOM to present Friends information. The proxy platform 101 identifies the changes to the DOM, creates HTML snippets, and identifies new images (e.g., friend avatars) to send to the proxy client 107 for rendering. As shown in user interface 931 of FIG. 9D, the loading message 925 is now replaced with the images and information for a first friend 933 and a second friend 935.

The processes described herein for providing distributed script processing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to provide distributed script processing as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of providing distributed script processing.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to providing distributed script processing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for providing distributed script processing. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing distributed script processing, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 103 for providing distributed script processing to the UE 105.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

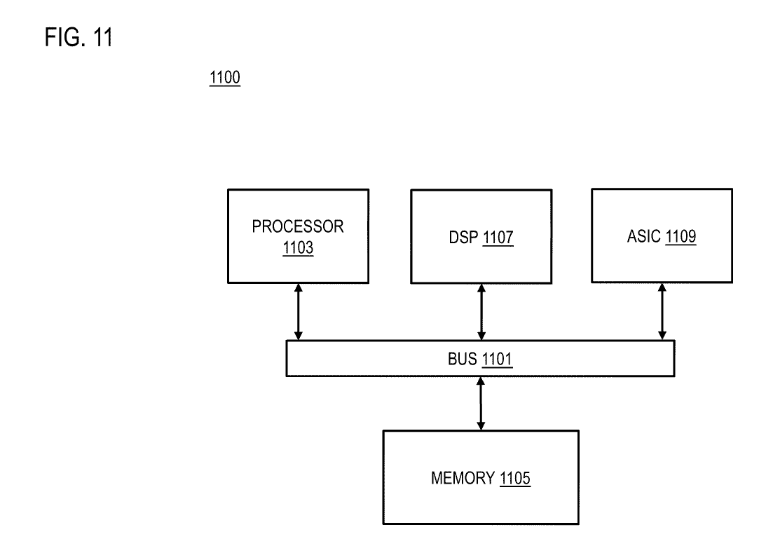

FIG. 11 illustrates a chip set or chip 1100 upon which an embodiment of the invention may be implemented. Chip set 1100 is programmed to provide distributed script processing as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of providing distributed script processing.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide distributed script processing. The memory 1105 also stores the data associated with or generated by the execution of the inventive steps.

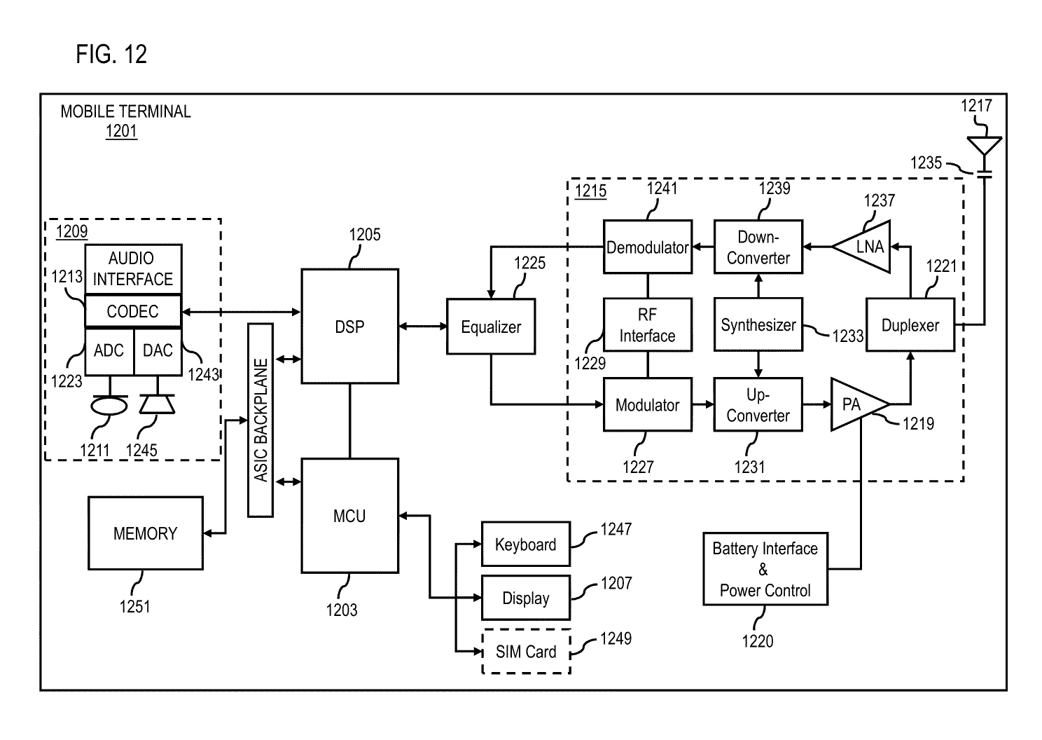

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of providing distributed script processing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of providing distributed script processing. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to provide distributed script processing. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request, from a device to a proxy server, for rendering web content including one or more scripts;
a processing of the web content, the one or more scripts, or a combination thereof to cause, at least in part, a determination of (a) whether to reuse media previously stored at the device for rendering the web content; (b) whether to generate a partial update of the web content; (c) whether to cause, at least in part, a processing of at least a portion of the web content, the one or more scripts, or a combination thereof using one or more local resources of the device; or (d) a combination thereof; and
at least one determination to cause, at least in part, the rendering of the web content based, at least in part, on the determination for transmission to the device.

2. A method of claim 1, wherein the (1) data and/or (2) information and/or (3) at least one signal are further based, at least in part, on the following:
a processing of the request to determine an address associated with the web content;
a first media list associated with one or more previous requests related to the address associated with the web content;
a generation of a second media list associated with the request; and
at least one determination of whether to reuse the media previously stored at the device based, at least in part, on a comparison of the first media list and the second media list.

3. A method of claim 2, wherein the (1) data and/or (2) information and/or (3) at least one signal are further based, at least in part, on the following:
at least one determination that the request specifies, at least in part, a new address associated with the web content; and
a clearing of the first media list, the second media list, or a combination thereof.

4. A method of claim 1, wherein the media previously stored at the device is maintained across a plurality of web content requests.

5. A method of claim 1, wherein the (1) data and/or (2) information and/or (3) at least one signal are further based, at least in part, on the following:
a storage of a first document object model associated with the web content rendered prior to receiving the request;
a processing of the request to render a second document object model associated with the web content; and
at least one determination of one or more nodes of the first document object model, the second document object model, or a combination thereof that have changed based, at least in part, on a comparison of the first document object model and the second document object model,
wherein the partial update of the web content is based, at least in part, on the one or more nodes that have changed.

6. A method of claim 5, wherein the (1) data and/or (2) information and/or (3) at least one signal are further based, at least in part, on the following:
a ratio of the one or more nodes that have changed to the one or more nodes that have not changed; and
at least one determination of whether to generate the partial update based, at least in part, on a comparison of the ratio to one or more threshold values.

7. A method of claim 5, wherein the (1) data and/or (2) information and/or (3) at least one signal are further based, at least in part, on the following:
at least one determination that the one or more nodes that have changed are associated with a subset of one or more attributes, one or more tags, one or more whitespaces, or a combination; and
at least one determination to ignore the one or more nodes associated with the subset when determining whether to generate the partial update.

8. A method of claim 1, wherein the one or more local resources of the device include, at least in part, one or more local scripting functions, and wherein the (1) data and/or (2) information and/or (3) at least one signal are further based, at least in part, on the following:
at least one determination of a first portion of the one or more scripts that can be performed by the one or more scripting functions, a second portion of the one or more scripts that cannot be performed by the one or more scripting functions, or a combination thereof; and
a generation of a document object model for the rendering of content that includes the first portion for local execution, the second portion for execution at the proxy server, or a combination thereof.

9. A method of claim 8, wherein the (1) data and/or (2) information and/or (3) at least one signal are further based, at least in part, on the following:
at least one determination of one or more timers associated with executing the first portion of the one or more scripts, the second portion of the one or more scripts, or a combination thereof,
wherein the one or more timers are managed at the device.

10. A method of claim 1, wherein the one or more local resources of the device include one or more native device functions including, at least in part, geolocation, and wherein the (1) data and/or (2) information and/or (3) at least one signal are further based, at least in part, on the following:
at least one determination that the one or more scripts access the one or more native device functions; and
at least one determination to cause, at least in part, the device to provide the one or more native device functions for execution of the one or more scripts.

11. An apparatus comprising:
at least one processor; and
at least one memory including computer program code for one or more programs,
the at least one memory and the computer program code configured to, with the at least one processor, cause the apparatus to perform at least the following,
receive a request, from a device to a proxy server, for rendering web content including one or more scripts;
process and/or facilitate a processing of the web content, the one or more scripts, or a combination thereof to cause, at least in part, a determination of (a) whether to reuse media previously stored at the device for rendering the web content; (b) whether to generate a partial update of the web content; (c) whether to cause, at least in part, a processing of at least a portion of the web content, the one or more scripts, or a combination thereof using one or more local resources of the device; or (d) a combination thereof; and
cause, at least in part, the rendering of the web content based, at least in part, on the determination for transmission to the device.

12. An apparatus of claim 11, wherein the apparatus is further caused to:
process and/or facilitate a processing of the request to determine an address associated with the web content;
determine a first media list associated with one or more previous requests related to the address associated with the web content;
cause, at least in part, a generation of a second media list associated with the request; and
determine whether to reuse the media previously stored at the device based, at least in part, on a comparison of the first media list and the second media list.

13. An apparatus of claim 12, wherein the apparatus is further caused to:
determine that the request specifies, at least in part, a new address associated with the web content; and
cause, at least in part, a clearing of the first media list, the second media list, or a combination thereof.

14. An apparatus of claim 11, wherein the media previously stored at the device is maintained across a plurality of web content requests.

15. An apparatus of claim 11, wherein the apparatus is further caused to:
cause, at least in part, a storage of a first document object model associated with the web content rendered prior to receiving the request;
process and/or facilitate a processing of the request to render a second document object model associated with the web content; and
determine one or more nodes of the first document object model, the second document object model, or a combination thereof that have changed based, at least in part, on a comparison of the first document object model and the second document object model,
wherein the partial update of the web content is based, at least in part, on the one or more nodes that have changed.

16. An apparatus of claim 15, wherein the apparatus is further caused to:
determine a ratio of the one or more nodes that have changed to the one or more nodes that have not changed; and
determine whether to generate the partial update based, at least in part, on a comparison of the ratio to one or more threshold values.

17. An apparatus of claim 15, wherein the apparatus is further caused to:
determine that the one or more nodes that have changed are associated with a subset of one or more attributes, one or more tags, one or more whitespaces, or a combination; and
determine to ignore the one or more nodes associated with the subset when determining whether to generate the partial update.

18. An apparatus of claim 11, wherein the one or more local resources of the device include, at least in part, one or more local scripting functions, and wherein the apparatus is further caused to:
determine a first portion of the one or more scripts that can be performed by the one or more scripting functions, a second portion of the one or more scripts that cannot be performed by the one or more scripting functions, or a combination thereof; and
cause, at least in part, a generation of a document object model for the rendering of content that includes the first portion for local execution, the second portion for execution at the proxy server, or a combination thereof.

19. An apparatus of claim 18, wherein the apparatus is further caused to:
determine one or more timers associated with executing the first portion of the one or more scripts, the second portion of the one or more scripts, or a combination thereof,
wherein the one or more timers are managed at the device.

20. An apparatus of claim 11, wherein the one or more local resources of the device include one or more native device functions including, at least in part, geolocation, and wherein the apparatus is further caused to:
determine that the one or more scripts access the one or more native device functions; and
determine to cause, at least in part, the device to provide the one or more native device functions for execution of the one or more scripts.
